(19) United States
(12) Patent Application Publication
(10) Pub. No.: US 2008/0119171 A1
(43) Pub. Date: May 22, 2008

(54) E-mail alert method and apparatus thereof

(75) Inventors: Tai-Shui Ho, Shanghai (CN); Shih-Kuang Tsai, Shanghai (CN); Liang Xiang, Shanghai (CN)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/976,867

(22) Filed: Oct. 29, 2007

(30) Foreign Application Priority Data
Nov. 22, 2006 (TW) 95143218

(51) Int. Cl. H04M 3/42

(52) U.S. Cl. 455/412.2

(57) ABSTRACT

An e-mail alert apparatus used in a cell phone includes a determining means and a first alert means. The determining means is used for determining whether a received e-mail belongs to a specific e-mail group. The first alert means is used for performing a first alert action when the received e-mail belongs to the specific e-mail group. In addition, an e-mail alert method used in the cell phone is disclosed as well.

### RELATED APPLICATIONS

This application claims priority to Taiwan Application Serial Number 95143218, filed Nov. 22, 2006, which is herein incorporated by reference.

### BACKGROUND

1. Field of Invention

The present invention relates to an E-mail alert apparatus and method thereof. More particularly, the present invention relates to an E-mail alert apparatus and an alert method used in cell phone.

2. Description of Related Art

The diversity of electronic products in the end user market has been greatly increased. New electronic products have been released rapidly and continuously after popularization of person computer. Conventional personal computer offers very wide range of functions such as playing audio and video files, image processing, network communication.etc. However, the size and weight of a conventional personal computer are always what users expect to be minimized. A lot of compact sized mobile electronic products, such as MP3 player, digital camera, cell phone and personal digital assistant (PDA) have been therefore invented to fulfill the requirement of mobility in today's electronic product market.

As the great improvement in software, hardware design and manufacturing technic, multiple compact sized mobile electronic devices are gradually integrated together to provide small sized mobile products with multiple functions. For example, a smart phone or a smart PDA not only provides the function of making phone call, but also offers functions of a digital camera and a conventional PDA. Such mobile electronic devices with integrated functions can therefore be regarded as a mobile personal computer.

Software applications can be executed on such mobile electronic device which is also featured by its e-mail capability. For instance, recent push e-mail service makes it possible to receive e-mail in a cell phone.

One feature in a regular push e-mail system is that every e-mail to be received will be processed in the same way. Some important e-mail will be possibly ignored when users receive a great amount of e-mails. Therefore, it is of great important for cell phone manufacturer to develop an e-mail alert method to solve such problem.

### SUMMARY

According to one embodiment of the present invention, one e-mail alert method used in a cell phone is provided, comprising:
(1) defining a specific e-mail group.
(2) determining whether a received e-mail belongs to the specific e-mail group.
(3) a first alert action is performed when the received e-mail belongs to the specific e-mail group.

According to another embodiment of the present invention, one e-mail alert method used in a cell phone is provided, comprising:
(1) defining a specific e-mail group.
(2) opening an e-mail list in the cell phone, wherein the e-mail list contains at least one e-mail.
(3) determining whether the e-mail belongs to the specific e-mail group.
(4) a first alert action is performed when the e-mail belongs to the specific e-mail group.

According to another embodiment of the present invention, an e-mail alert apparatus comprising a determining means and a first alert means used in a cell phone is provided. The determining means determine whether a received e-mail belongs to a specific e-mail group. A first alert action will be performed by the first alert means when the received e-mail belongs to the specific e-mail group.

According to another embodiment of the present invention, an e-mail alert apparatus comprising a build module, an activator, a determining means, and a first alert means used in a cell phone is provided. The build module is used to build a specific e-mail group. The activator is used to open an e-mail list in the cell phone. The e-mail list contains, at least, an e-mail. The determining means determines whether the e-mail belongs to the specific e-mail group. The first alert action will be performed by the first alert means when the e-mail belongs to the specific e-mail group.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a flow chart of an e-mail alert method according to one embodiment of the present invention;

FIG. 1B is a flow chart for defining a specific e-mail group as shown in FIG. 1A.

FIG. 2 is a flow chart of an e-mail alert method according to another embodiment of the present invention;

FIG. 3A is a function block diagram of an e-mail alert apparatus according to another embodiment of the present invention;

FIG. 3B is a function block diagram of build module as shown in FIG. 3A; and

FIG. 4 is a function block diagram of an e-mail alert apparatus according to yet another embodiment of the present invention.

### DETAILED DESCRIPTION

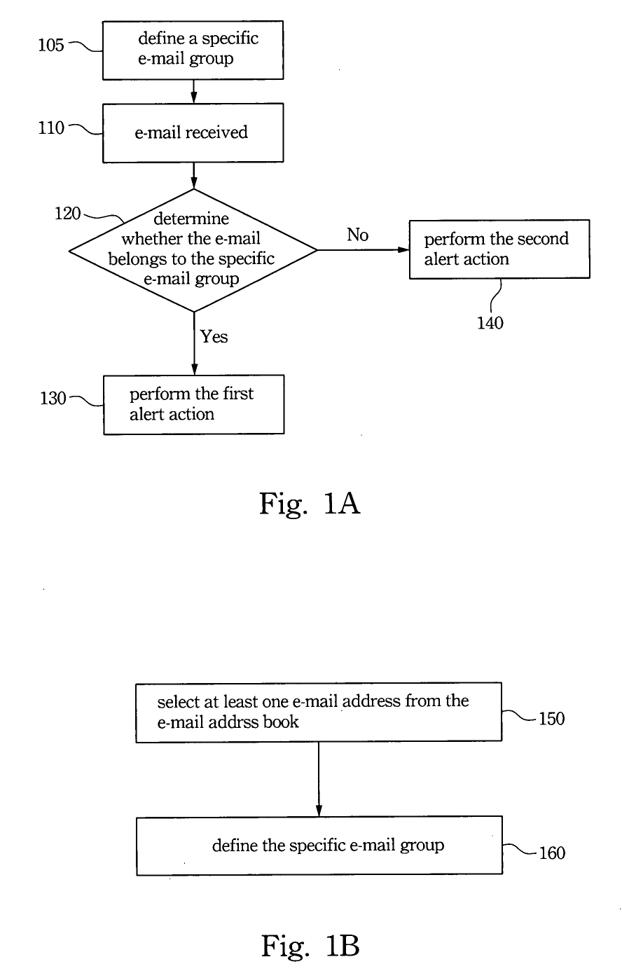

Refer to FIG. 1A. FIG. 1A is a flow chart of an e-mail alert method according to one embodiment of the present invention. An e-mail alert method used in a cell phone is provided, comprising:
(1) defining a specific e-mail group (step 105)
(2) determining whether a received e-mail (step 110) belongs to the specific e-mail group (step 120).
(3) a first alert action (step 130) is performed when the received e-mail belongs to the specific e-mail group. On the other hand, a second alert action (step 140) is performed when the received e-mail does not belong to the specific e-mail group.

The first alert action is different from the second alert action. For example, a first ring tone (the first alert action can be playing the first ring tone) is played when the received e-mail belongs to the specific e-mail group. A second ring tone (the second alert action can be playing the second ring tone) is played when the received e-mail does not belong to the specific e-mail group. Similarly, the first ring tone is different from the second ring tone. It is easily understood that different ring tones as the first and the second alert actions is only one of the examples. The first and the second alert actions can also be a proper notification (for example, vibration). People skilled in the art can select proper notification if necessary.

Defining the specific e-mail group mentioned above can be finished by Push E-mail which has been built in most conventional cell phones. Therefore, compatibility problem can be avoided if Push e-mail is used to define e-mail group, the development of such e-mail alert method can be largely simplified.

Refer to FIG. 1B. FIG. 1B is a flow chart for defining a specific e-mail group as shown in FIG. 1A. As shown in FIG. 1B, defining the specific e-mail group comprises:
(1) selecting at least one e-mail address from an e-mail address book of the cell phone (step 150); and
(2) defining the specific e-mail group (step 160) on the basis of the e-mail address.

In other words, once if an e-mail received by the cell phone can be matched up with any of the e-mail addresses in the specific e-mail group, it indicates that this e-mail belongs to the specific e-mail group. Oppositely, once if an e-mail received by the cell phone can not be matched up with any of the e-mail addresses in the specific e-mail group, it indicates that this e-mail does not belong to the specific e-mail group.

It should be understood that e-mail address is used to determine whether one e-mail belongs to the specific e-mail group, but other information such as keyword, subject or other proper components of an e-mail can also be used for determination.

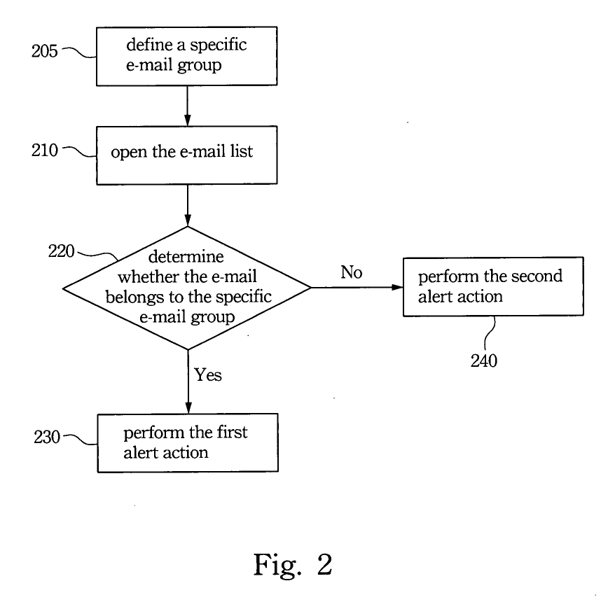

Refer to FIG. 2. FIG. 2 is a flow chart of an e-mail alert method according to another embodiment of the present invention. As shown in FIG. 2, an e-mail alert method used in a cell phone comprises:
(1) defining a specific e-mail group (step 205)
(2) opening an e-mail list in the cell phone, the e-mail list contains, at least, an e-mail (step 210).
(3) determining whether the e-mail belongs to the specific e-mail group (step 220).
(4) a first alert action (step 230) is performed when the e-mail belongs to the specific e-mail group. A second alert action (step 240) is performed when the e-mail does not belong to the specific e-mail group.

The first alert action is different from the second alert action. For example, a first symbol (the first alert action can be marking the first symbol on the e-mail) is marked on the e-mail when the e-mail belongs to the specific e-mail group. A second symbol (the second alert action can be marking the second symbol on the e-mail) is marked on the e-mail when the e-mail does not belong to the specific e-mail group. Similarly, the first symbol is different from the second symbol. It is easily understood that different symbols as the first and the second alert actions is only one of the examples. The first and the second alert actions can also be a proper notification. Cell phone user can select proper notification by themselves.

Defining the specific e-mail group mentioned above can be finished by Push E-mail. Its detailed description is skipped because it is identical to that described in previous embodiment.

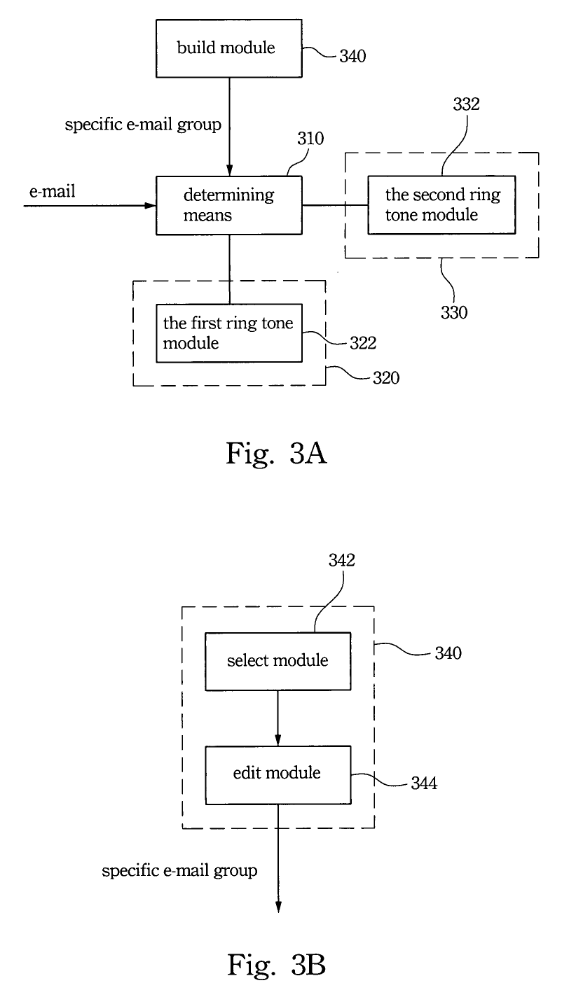

Refer to FIG. 3A, FIG. 3A is a function block diagram of an e-mail alert apparatus according to another embodiment of the present invention. As shown in FIG. 3A, an e-mail alert apparatus used in a cell phone includes a determining means 310 and a first alert means 320. The determining means 310 is used to determine whether a received e-mail belongs to a specific e-mail group. A first alert action is performed by the first alert means 320 when the received e-mail belongs to the specific e-mail group.

The e-mail alert apparatus of this embodiment can also comprise a second alert means 330. A second alert action can be performed when the received e-mail does not belong to the specific e-mail group. The above mentioned first alert action is different from the second alert action.

The first alert means 320 can comprise a first ring tone module 322 for playing a first ring tone when the received e-mail belongs to the specific e-mail group. The second alert means 330 can comprise a second ring tone module 332 for playing a second ring tone when the received e-mail does not belong to the specific e-mail group. Similarly, the first ring tone is different from the second ring tone. It is easily to be understood that different ring tones played by the first and the second ring tone module is only one of the examples. The first and the second alert means can comprise other proper modules (for example, vibration module). People skilled in the art can select proper module if necessary.

Furthermore, the e-mail alert apparatus can comprise a build module 340 which utilizes Push E-mail to build specific e-mail group. Push E-mail has been built in most conventional cell phones. Therefore, compatibility problem can be avoided if Push E-mail is used to define e-mail group, the development of such e-mail alert method can be largely simplified.

Refer to FIG. 3B. FIG. 3B is a function block diagram of build module as shown in FIG. 3A. As shown in FIG. 3B, the build module 340 comprises a select module 342 and an edit module 344. The select module 342 is used to select at least one e-mail address from an e-mail address book of the cell phone. The edit module 344 is to edit the specific e-mail group according to the selected e-mail address.

In other words, once if an e-mail received by the cell phone can be matched up with any of the e-mail addresses in the specific e-mail group, it indicates that this e-mail belongs to the specific e-mail group. Oppositely, once if an e-mail received by the cell phone can not be matched up with any of the e-mail addresses in the specific e-mail group, it indicates that this e-mail does not belong to the specific e-mail group.

It should be understood that e-mail address is used to determine whether one e-mail belongs to the specific e-mail group, but other information such as keyword, subject or other proper components of an e-mail can also be used for determination.

The above mentioned determining means 310, the first alert means 320, the first ring tone module 322, the second alert means 330, the second ring tone module 332, the build module 340, the select module 342 and the edit module 344 can be either software or hardware. They do not need to be completely software or completely hardware. These means and modules can be a combination of both software and hardware.

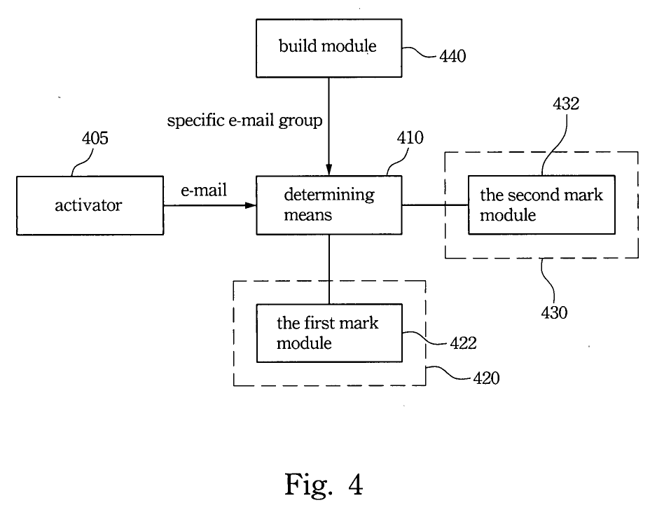

Refer to FIG. 4. FIG. 4 is a function block diagram of an e-mail alert apparatus according to yet another embodiment of the present invention. As shown in FIG. 4, an e-mail alert apparatus used in a cell phone comprises an activator 405, a determining means 410 and a first alert means 420. The activator 405 is used to open an e-mail list in the cell phone. The e-mail list contains, at least, one e-mail. The determining means 410 is used to determine whether the e-mail belongs to the specific e-mail group. A first alert action is performed by the first alert means 420 when the e-mail belongs to the specific e-mail group.

The e-mail alert apparatus of this embodiment can also comprise a second alert means 430. A second alert action can be performed when the e-mail does not belong to the specific e-mail group. The above mentioned first alert action is different from the second alert action.

The first alert means 420 can comprise a first mark module 422 for marking a first symbol on the e-mail when the e-mail belongs to the specific e-mail group. The second alert means 430 can comprise a second mark module 432 for marking a second symbol on the e-mail when the e-mail does not belong to the specific e-mail group. Similarly, the first symbol is different from the second symbol. It is easily understood that different symbol marked by the first and the second mark module is only one of the examples. The first and the second alert means can comprise other proper modules. People skilled in the art can select proper module if necessary.

Furthermore, the e-mail alert apparatus as shown in FIG. 4 can comprise a build module 440. Its detailed description is skipped because it is identical to that described in previous embodiment.

The above mentioned activator 405, determining means 410, the first alert means 420, the first ring tone module 422, the second alert means 430, the second ring tone module 432, the build module 440, the select module 342 can be either software or hardware. They do not need to be completely software or completely hardware. These means and modules can be a combination of both software and hardware.

Although the present invention has been described in considerable detail with reference to certain embodiments thereof, other embodiments are possible. Therefore, their spirit and scope of the appended claims should no be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An e-mail alert method used in a cell phone, the e-mail alert method comprising:
defining a specific e-mail group;
determining whether a received e-mail belongs to the specific e-mail group; and
performing a first alert action when the received e-mail belongs to the specific e-mail group.

2. The e-mail alert method of claim 1, further comprising:
performing a second alert action when the received e-mail does not belong to the specific e-mail group, wherein the first alert action is different from the second alert action.

3. The e-mail alert method of claim 1, wherein the first alert action is playing a first ring tone.

4. The e-mail alert method of claim 3, further comprising:
playing a second ring tone when the received e-mail does not belong to the specific e-mail group, wherein the first ring tone is different from the second ring tone.

5. The e-mail alert method of claim 1, wherein defining the specific e-mail group is finished by Push E-mail.

6. The e-mail alert method of claim 5, wherein defining the specific e-mail group comprises:
selecting at least one e-mail address from an e-mail address book of the cell phone; and
defining the specific e-mail group on the basis of the e-mail address.

7. An e-mail alert method used in a cell phone, the e-mail alert method comprising:
defining a specific e-mail group;
opening an e-mail list in the cell phone, wherein the e-mail list contains at least one e-mail;
determining whether the e-mail belongs to the specific e-mail group; and
performing a first alert action when the e-mail belongs to the specific e-mail group.

8. The e-mail alert method of claim 7, further comprising:
performing a second alert action when the e-mail does not belong to the specific e-mail group, wherein the first alert action is different from the second alert action.

9. The e-mail alert method of claim 7, wherein the first alert action is marking a first symbol on the e-mail.

10. The e-mail alert method of claim 9, further comprising:
marking a second symbol on the e-mail when the e-mail does not belong to the specific e-mail group, wherein the first symbol is different from the second symbol.

11. The e-mail alert method of claim 7, wherein defining the specific e-mail group is finished by Push E-mail.

12. The e-mail alert method of claim 11, wherein defining the specific e-mail group comprises:
selecting at least one e-mail address from an e-mail address book of the cell phone; and
defining the specific e-mail group on the basis of the e-mail address.

13. An e-mail alert apparatus used in a cell phone, the e-mail alert apparatus comprising:
a determining means for determining whether a received e-mail belongs to a specific e-mail group; and
a first alert means for performing a first alert action when the received e-mail belongs to the specific e-mail group.

14. The e-mail alert apparatus of claim 13, further comprising:
a second alert means for performing a second alert action when the received e-mail does not belong to the specific e-mail group, wherein the first alert action is different from the second alert action.

15. The e-mail alert apparatus of claim 14, wherein the first alert means comprise a first ring tone module for playing a first ring tone when the received e-mail belongs to the specific e-mail group.

16. The e-mail alert apparatus of claim 15, further comprising:
a second ring tone module, included in the second alert means, for playing a second ring tone when the received e-mail does not belong to the specific e-mail group.

17. The e-mail alert apparatus of claim 13, further comprising:
a build module for building the specific e-mail group by Push E-mail.

18. The e-mail alert apparatus of claim 17, wherein the build module comprises:
a select module for selecting at least one e-mail address from an e-mail address book of the cell phone; and
an edit module for editing the specific e-mail group according to the selected e-mail address.

19. An e-mail alert apparatus used in a cell phone, the e-mail alert apparatus comprising:
a build module for building a specific e-mail group;
an activator for opening an e-mail list in the cell phone, wherein the e-mail list contains at least one e-mail;
a determining means for determining whether the e-mail belongs to the specific e-mail group; and
a first alert means for performing a first alert action when the e-mail belongs to the specific e-mail group.

20. The e-mail alert apparatus of claim 19, further comprising:
a second alert means for performing a second alert action when the e-mail does not belong to the specific e-mail group, wherein the first alert action is different from the second alert action.

21. The e-mail alert apparatus of claim 19, wherein the first alert means comprise a first mark module for marking a first symbol on the e-mail when the e-mail belongs to the specific e-mail group.

22. The e-mail alert apparatus of claim 21, further comprising:
a second mark module for marking a second symbol on the e-mail when the e-mail does not belong to the specific e-mail group, wherein the first symbol is different from the second symbol.

23. The e-mail alert apparatus of claim 19, wherein the build module uses Push E-mail to build the specific e-mail group.

24. The e-mail alert apparatus of claim 23, wherein the build module comprises:
a select module for selecting at least one e-mail address from an e-mail address book of the cell phone; and
an edit module for editing the specific e-mail group according to the selected e-mail address.
